(19) United States
(12) Patent Application Publication
(10) Pub. No.: US 2019/0260827 A1
(43) Pub. Date: Aug. 22, 2019

(54) EDGE COMPUTING SYSTEM, EDGE SERVER, AND SYSTEM CONTROL METHOD

(71) Applicant: NEC Corporation, Tokyo (JP)

(72) Inventor: Kaori Tajima, Tokyo (JP)

(73) Assignee: NEC Corporation, Tokyo (JP)

(21) Appl. No.: 16/281,754

(22) Filed: Feb. 21, 2019

(30) Foreign Application Priority Data
Feb. 21, 2018 (JP) 2018-028585

(51) Int. Cl. H04L 29/08; H04L 12/851; H04L 12/855; G06F 9/50

(52) U.S. Cl. CPC H04L 67/1025; H04L 47/2433; G06F 9/5077; H04L 67/1008; G06F 9/505; H04L 47/2466

(57) ABSTRACT

To appropriately allocate program processing to edge servers in an edge computing system, an edge server is connected and communicates with one or more devices that transmit input data, and the edge server includes a partitioning information acquisition unit that acquires, from a backend server, priority information indicating which of a plurality of edge servers that acquire the same partitioned model is to preferentially execute the partitioned model, and a management unit that manages the number of connected and communicating devices. The management unit compares the number of devices with a predetermined threshold and requests the other edge servers to update the priority information according to a comparison result.

### INCORPORATION BY REFERENCE

This application is based upon and claims the benefit of priority from Japanese patent application No. 2018-28585, filed on Feb. 21, 2018, the disclosure of which is incorporated herein in its entirety by reference.

### TECHNICAL FIELD

The present disclosure relates to an edge computing system, an edge server, and a system control method.

### BACKGROUND ART

Various systems have been built recently by use of IoT (Internet of Things) technology. Those systems collect and process data of various devices (smartphones, tablet terminals, various types of sensors etc.) by using cloud computing. There are, however, problems such as data traffic increase and device communication delay, and edge computing attracts attention as a technique to solve those problems.

Edge computing is a technique that distributes small edge servers to locations near devices and performs processing in each edge server instead of a cloud in order to reduce the communication load and the occurrence of delay. Generally, data acquired from devices and a pre-trained model by machine learning for data analysis are stored in edge servers.

International Patent Publication No. WO 2016/043120 discloses a technique related to edge computing. This technique partitions user information to generate a plurality of partitioned information, and determines the destination to save the user information based on a change in the state of a network system including an edge server. Further, Japanese Unexamined Patent Application Publication No. 2010-009495 discloses a technique related to partitioning. This technique partitions a program and performs parallel execution.

### SUMMARY

In edge computing, the placement and configuration of connected devices vary depending on various factors such as performing processing for providing a service that requires instantaneous response or processing for providing a service that requires collaboration with another system. Therefore, a model for data analysis needs to be appropriately distributed and allocated to edge servers according to environment.

The technique disclosed in International Patent Publication No. WO 2016/043120 is a technique about simple data partitioning and storage, and it does not deal with appropriate allocation of a program such as a pre-trained model. Further, although the technique disclosed in Japanese Unexamined Patent Application Publication No. 2010-009495 relates to program partitioning, it is a technique that executes a partitioned program in a single machine, which is not easily applicable to edge computing.

Therefore, there is still a demand for a technique that appropriately allocates program processing to edge servers in an edge computing system. In view of this, one of objects to be attained by an embodiment disclosed in this specification is to provide an edge computing system, an edge server, a system control method, and a program capable of appropriately allocating program processing to edge servers in an edge computing system.

In order to accomplish the aforementioned object, the present disclosure provides an edge computing system including:
a backend server; and
a plurality of edge servers, wherein
the backend server includes
   a model partitioning unit configured to partition a model into partitioned models, the model being a program that performs computation including a plurality of processing steps on input data;
   a partitioned model allocation unit configured to allocate each of the partitioned models to one or more of the edge servers;
   a priority creation unit configured to create priority information indicating which edge server among the plurality of edge servers to which the same partitioned model is allocated is to preferentially execute the partitioned model; and
   a partitioning information transmitting unit configured to transmit, to the edge server, the partitioned model, transfer destination information indicating an allocation destination of the partitioned model including a processing step subsequent to this partitioned model, and the priority information based on allocation by the partitioned model allocation unit,
each of the edge servers is connected and communicates with one or more devices that transmit the input data,
each of the edge servers includes
   a partitioning information acquisition unit configured to acquire, from the backend server, the partitioned model, the transfer destination information and the priority information;
   a management unit configured to manage the number of connected and communicating devices;
   a computation unit configured to execute a computation using the partitioned model; and
   a computation result transfer unit configured to transfer a computation result of the computation unit to another one of the edge servers specified based on the transfer destination information and the priority information, and
the management unit compares the number of devices with a predetermined threshold, and requests the other edge servers to update the priority information according to a comparison result.

Further, the present disclosure provides an edge server connected and communicating with one or more devices that transmit input data to be input to a model being a program that performs computation including a plurality of processing steps, including:
a partitioning information acquisition unit configured to acquire, from a backend server, a partitioned model generated by partitioning the model, transfer destination information indicating another edge server that acquires the partitioned model including a processing step subsequent to this partitioned model, and priority information indicating which edge server among the plurality of edge servers that acquire the same partitioned model is to preferentially execute this partitioned model;
a management unit configured to manage the number of connected and communicating devices;
a computation unit configured to execute a computation using the partitioned model; and
a computation result transfer unit configured to transfer a computation result of the computation unit to another one of the edge servers specified based on the transfer destination information and the priority information, wherein
the management unit compares the number of devices with a predetermined threshold, and requests the other edge servers to update the priority information according to a comparison result.

The present disclosure provides a system control method including:
managing the number of connections with a device that transmits input data to be input to a model being a program that performs computation including a plurality of processing steps;
acquiring, from a backend server, a partitioned model generated by partitioning the model, transfer destination information indicating another edge server that acquires the partitioned model including a processing step subsequent to this partitioned model, and priority information indicating which edge server among a plurality of edge servers that acquire the same partitioned model is to preferentially execute the partitioned model;
executing computation using the partitioned model;
transferring a computation result to another one of the edge servers specified based on the transfer destination information and the priority information; and
comparing the number of connections with a predetermined threshold, and requesting the other edge servers to update the priority information according to a comparison result.

### BRIEF DESCRIPTION OF THE DRAWINGS

The above and other aspects, features and advantages of the present disclosure will become more apparent from the following description of certain exemplary embodiments when taken in conjunction with the accompanying drawings, in which:

FIG. 1 is a block diagram showing an example of the configuration of an edge computing system according to the overview of an embodiment.

FIG. 2 is a block diagram showing an example of the configuration of the edge computing system according to the embodiment.

FIG. 3 is a block diagram showing an example of the hardware configuration of a backend server and an edge server according to the embodiment.

FIG. 4 is a block diagram showing an example of the functional configuration of the backend server according to the embodiment.

FIG. 5 is a schematic diagram showing the overview of data analysis processing by a model.

FIG. 6 is a flowchart showing an example of an operation in the backend server according to the embodiment.

FIG. 7 is a view showing an example of partitioned model management information.

FIG. 8 is a view showing an example of edge server management information.

FIG. 9 is a view showing an example of initial partitioned model information.

FIG. 10 is a view showing an example of an allocation list.

FIG. 11 is a view showing an example of a transfer destination list.

FIG. 12 is a block diagram showing an example of the functional configuration of the edge server according to the embodiment.

FIG. 13A is a flowchart showing an example of an operation related to data analysis in the edge server according to the embodiment.

FIG. 13B is a flowchart showing an example of an operation related to data analysis in the edge server according to the embodiment.

FIG. 14 is a view showing an example of transfer data.

FIG. 15 is a flowchart showing an example of a modification operation of a transfer priority.

### EXAMPLE EMBODIMENTS

### Overview of Embodiment

Prior to the detailed description of an embodiment, the overview of the embodiment is described hereinafter.

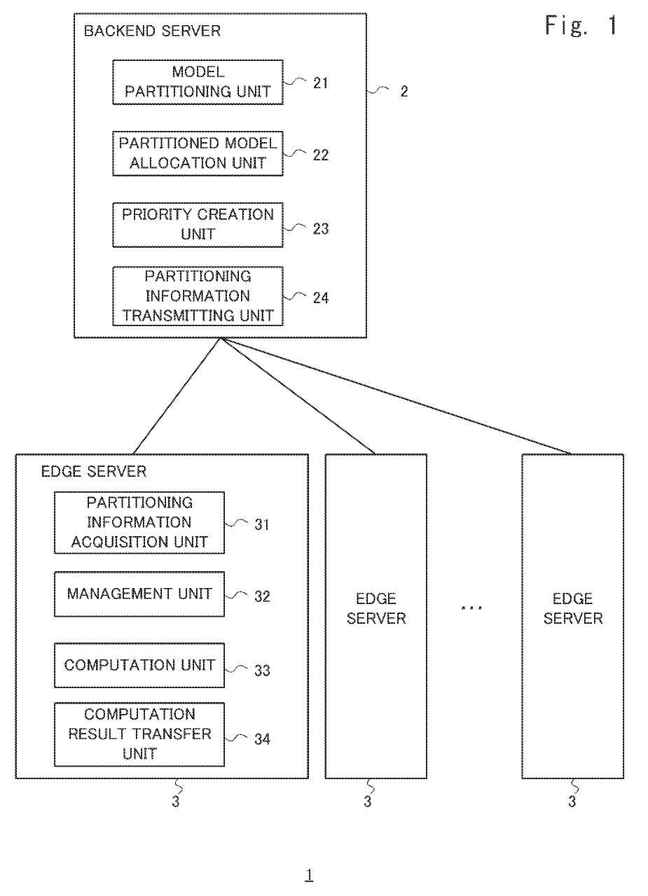

FIG. 1 is a block diagram showing an example of the configuration of an edge computing system 1 according to the overview of an embodiment. The edge computing system 1 includes a backend server 2 and a plurality of edge servers 3 capable of communicating with the backend server 2. Each of the edge servers 3 is connected and communicates with one or more devices that transmit data (which are not shown in FIG. 1).

The edge computing system 1 is a system that performs computation using a model on input data. This model is a program that receives data transmitted by the above-described device as input data, and performs computation including a plurality of processing steps on this input data. The model may include a model trained by machine learning or the like, for example.

The edge computing system 1 executes a computation by a model in a distributed manner over the plurality of edge servers 3. For example, in the edge computing system 1, a first edge server 3 performs computation of a certain processing step and, using this computation result, a second edge server 3 performs computation of the subsequent processing step. Computation of all processing steps is carried out in this way. In sum, each edge server 3 executes part of processing steps of a model, and thereby the entire system executes a computation of the entire model.

The backend server 2 includes a model partitioning unit 21, a partitioned model allocation unit 22, a priority creation unit 23, and a partitioning information transmitting unit 24.

The model partitioning unit 21 partitions the above-described model into partitioned models. The partitioned model is a partial model that is segmented by partitioning.

The partitioned model allocation unit 22 allocates each of partitioned models to one or more edge servers 3. The partitioned model allocation unit 22 determines which edge server 3 is to perform computation by the partitioned model. Note that, when the same partitioned model is allocated to a plurality of edge servers 3, any one of the edge servers 3 may carry out computation by this partitioned model.

The priority creation unit 23 creates priority information indicating which edge server among the plurality of edge servers 3 to which the same partitioned model is allocated is to preferentially execute this partitioned model.

The partitioning information transmitting unit 24 transmits a partitioned model, transfer destination information, which is information indicating the allocation destination of a partitioned model including the subsequent processing step to this partitioned model, and the priority information to the edge server 3 based on allocation by the partitioned model allocation unit 22. The transfer destination information is, in other words, information indicating to which of the edge servers 3 a computation result by the partitioned model is to be transferred in order to perform processing in a series of processing steps. Thus, the transfer destination information is information indicating which of the edge servers 3 is likely to perform computation in the subsequent processing step.

Each of the edge servers 3 includes a partitioning information acquisition unit 31, a management unit 32, a computation unit 33, and a computation result transfer unit 34.

The partitioning information acquisition unit 31 acquires the partitioned model, the transfer destination information and the priority information from the backend server 2.

The management unit 32 manages the number of devices connected and communicating with the edge server 3. Note that the management unit 32 may further manage the resource state of the edge server 3 or the like, not limited to the number of devices.

The computation unit 33 executes a computation using the partitioned model acquired from the backend server 2.

The computation result transfer unit 34 transfers a computation result of the computation unit 33 to another edge server 3 specified based on the transfer destination information and the priority information. The subsequent processing step is thereby executed in this another edge server 3. Note that, as described earlier, there is a case where the same partitioned model is allocated to the plurality of edge servers 3. In this case, computation by this partitioned model is executed by any of those edge servers 3 based on the priority information. Therefore, the computation result transfer unit 34 specifies a transfer destination based on the transfer destination information and the priority information.

The management unit 32 compares the number of devices connected and communicating with the edge server 3 with a predetermined threshold, and requests the other edge servers 3 to update the priority information according to the comparison result. To be specific, when the number of devices exceeds a predetermined threshold, for example, the management unit 32 requests to reduce the priority of the server of its own (i.e., the edge server 3 where the number of devices exceeds the predetermined threshold). As the number of connected devices is greater, the amount of data transmitted from the devices to the edge server 3 increases, and the processing load increases accordingly. Thus, by updating the priority information, it is possible to prevent a processing step subsequent to a processing step performed by a certain edge server 3 from being performed by the edge server 3 with heavy processing load. Thus, according to the edge computing system 1, it is possible to appropriately allocate program processing to the edge servers 3 according to system environment.

### Details of Embodiment

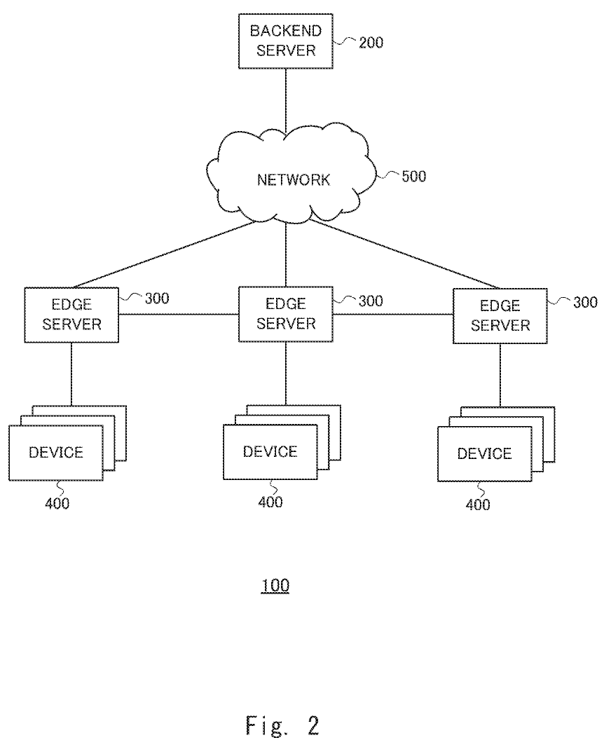

The details of the embodiment are described next. FIG. 2 is a block diagram showing an example of the configuration of an edge computing system 100 according to the embodiment. As shown in FIG. 2, the edge computing system 100 includes a backend server 200, a plurality of edge servers 300, and a plurality of devices 400. The backend server 200 is the equivalent of the backend server 2 in FIG. 1, and the edge server 300 is the equivalent of the edge server 3 in FIG. 1.

The backend server 200 is connected to the plurality of edge servers 300 through a network 500 such as WAN (Wide Area Network) or the Internet, and manages the edge servers 300. Each of the edge servers 300 is connected to communicate with one or more devices 400 in a wired or wireless way. Note that the topology between the edge server 300 and the device 400 is a topology according to the communication feature of the device, for example. The edge servers 300 are devices that perform computation by a partitioned model as described later. The edge servers 300 can communicate with each other in a wired or wireless way. The devices 400 are devices such as various types of sensors, actuators or smartphones, and acquire data to be processed. The number and variety of devices vary by each edge server 300.

The backend server 200 and the edge servers 300, which are principal elements in this embodiment, are described hereinafter.

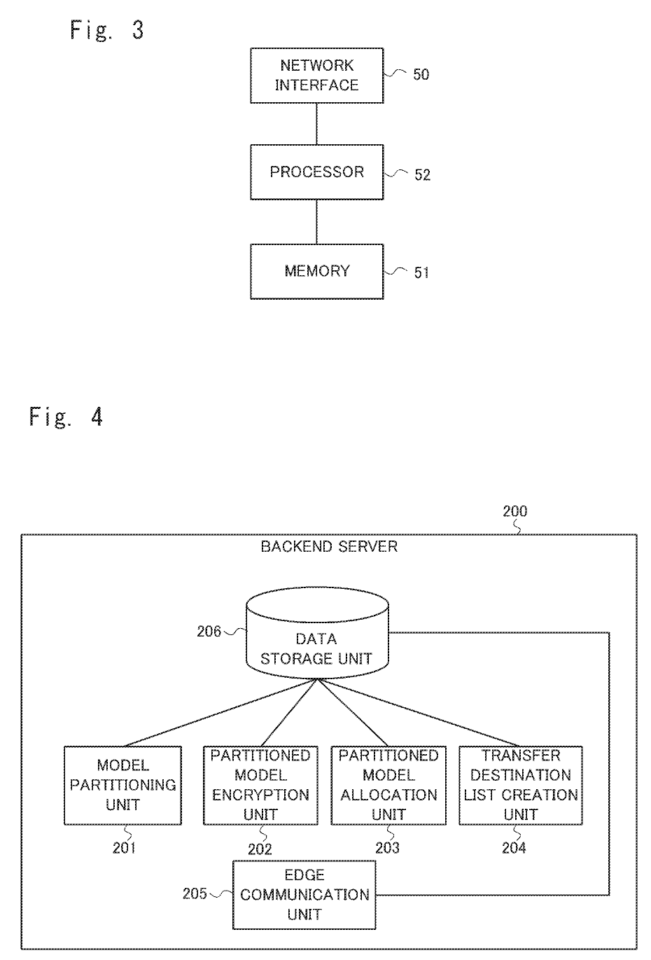

FIG. 3 is a block diagram showing an example of the hardware configuration of the backend server 200 and the edge servers 300. As shown in FIG. 3, each of the backend server 200 and the edge servers 300 includes a network interface 50, a memory 51 and a processor 52, for example.

The network interface 50 is used to communicate with another device. The network interface 50 may include a network interface card (NIC), for example.

The memory 51 is composed of a combination of a volatile memory and a nonvolatile memory. In addition to the memory 51, the backend server 200 and the edge servers 300 may further include a storage device such as a hard disk.

The memory 51 is used for storing software (computer program) containing one or more instructions executed by the processor 52.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The processor 52 loads and executes software (computer program) from the memory 51 and thereby performs each processing of the backend server 200 or each processing of the edge server 300, which are described later. In this manner, the backend server 200 and the edge servers 300 have functions as computers. The processor 52 may be a microprocessor, an MPU (Micro Processor Unit) or a CPU (Central Processing Unit), for example. The processor 52 may include a plurality of processors.

The memory 51 or the storage device may be used as a data storage unit 206 or a data storage unit 302.

Note that the device 400 also has the same hardware configuration as shown in FIG. 3, and it has functions as a computer.

FIG. 4 is a block diagram showing an example of the functional configuration of the backend server 200. As shown in FIG. 4, the backend server 200 includes a model partitioning unit 201, a partitioned model encryption unit 202, a partitioned model allocation unit 203, a transfer destination list creation unit 204, an edge communication unit 205, and a data storage unit 206.

The model partitioning unit 201 is the equivalent of the model partitioning unit 21 in FIG. 1, and it partitions a model, which is a program that performs computation including a plurality of processing steps on input data, into partitioned models. The model partitioning unit 21 refers to a model before partitioning stored in the data storage unit 206, partitions this model and thereby generates partitioned models.

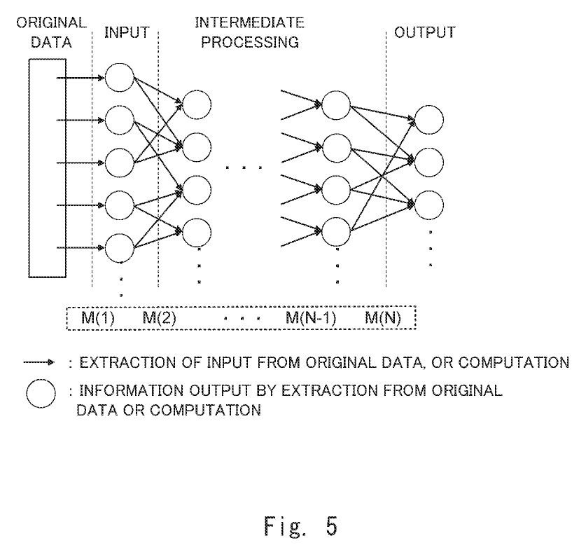

Partitioning of a model is described hereinafter. FIG. 5 is a schematic diagram showing the overview of data analysis processing by a model. The model extracts information to be analyzed from original data and performs analysis on the extracted information. The original data is data transmitted from the device 400 to the edge serer 300, and it is also called input data.

For analysis processing, a model that is previously trained by machine learning or the like (which is referred to hereinafter as a pre-trained model), for example, is used. Specifically, as shown in FIG. 5, the data analysis processing by a model according to this embodiment performs intermediate processings (analysis processing) by using information extracted from original data as an input of a pre-trained model, and thereby obtains an output, which is a result of processing the original data.

Each of extraction of information to be analyzed from original data and intermediate processings for obtaining an output from an input of a pre-trained model can be expressed as partitioned models independent of each other. When a partitioned model that extracts information from original data is M(1) and a partitioned model for each intermediate processings when performing N−1 times of intermediate processing is M(2) to M(N), a final output is obtained by carrying out computation of the partitioned models M(1) to M(N) on the original data. In this embodiment, a model is partitioned into partitioned models M(1) to M(N) in this manner. Then, each of the partitioned models is allocated to the edge servers 300 so as to implement processing of the entire model by handover of processing among the plurality of edge servers 300. Note that the pre-trained model may be created in advance by the backend server 200. In other words, training of a model may be done by the backend server 200.

The partitioned model encryption unit 202 encrypts the partitioned models obtained by partitioning by the model partitioning unit 201. Note that the partitioned model encryption unit 202 performs encryption in such a way that a decryption key required for decryption is different for each partitioned model.

The partitioned model allocation unit 203 is the equivalent of the partitioned model allocation unit 22 in FIG. 1, and it allocates the partitioned models generated by the model partitioning unit 201 to the edge servers 300. Specifically, the partitioned model allocation unit 203 allocates each of the partitioned models to one or more edge servers 300. Note that the partitioned model allocation unit 203 may allocate some of the partitioned models or all of the partitioned models to the plurality of edge servers 300.

Because a model is to analyze particular original data (input data), it can be associated with the device 400 that transmits this particular original data. There can be a plurality of types of models associated with a certain device 400. The backend server 200 has information about the devices 400 to which the edge servers 300 are connected, and therefore the backend server 200 can make association between the edge servers 300 and the devices 400. Specifically, the backend server 200 can recognize which of the edge servers 300 has the original data associated with a certain model. The partitioned model allocation unit 203 determines allocation based on information about the edge server 300 having the original data to be input to the model and the number of the devices 400 connected to the edge server 300. Note that a specific method of determining allocation is described later.

The transfer destination list creation unit 204 creates a transfer destination list according to the allocation of the partitioned models determined by the partitioned model allocation unit 203. The transfer destination list is a list containing the transfer destination information and the priority information described above. The transfer destination list creation unit 204 is the equivalent of the priority creation unit 23 in FIG. 1.

The edge communication unit 205 communicates with the edge server 300 through the network 500. The edge communication unit 205 transmits, to the edge server 300, a partitioned model, a decryption key required to decrypt the partitioned model, the transfer destination list and the like, for example. The edge communication unit 205 is the equivalent of the partitioning information transmitting unit 24 in FIG. 1. Further, the edge communication unit 205 acquires information transmitted from the edge server 300.

The data storage unit 206 stores various data necessary for processing in the backend server 200. The data storage unit 206 stores a model before partitioning, an edge list, edge server management information, partitioned models, partitioned model management information, initial partitioned model information, an allocation list, a transfer destination list and the like, for example.

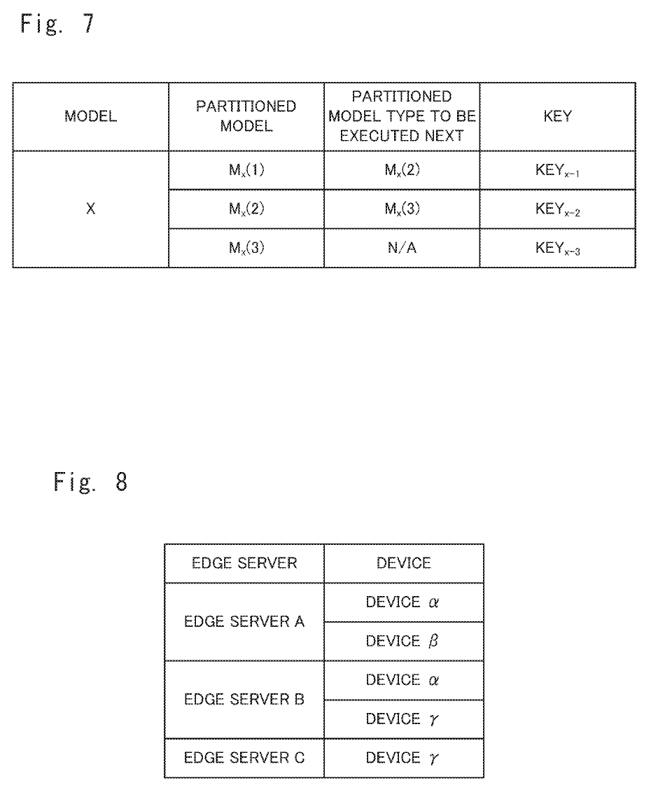

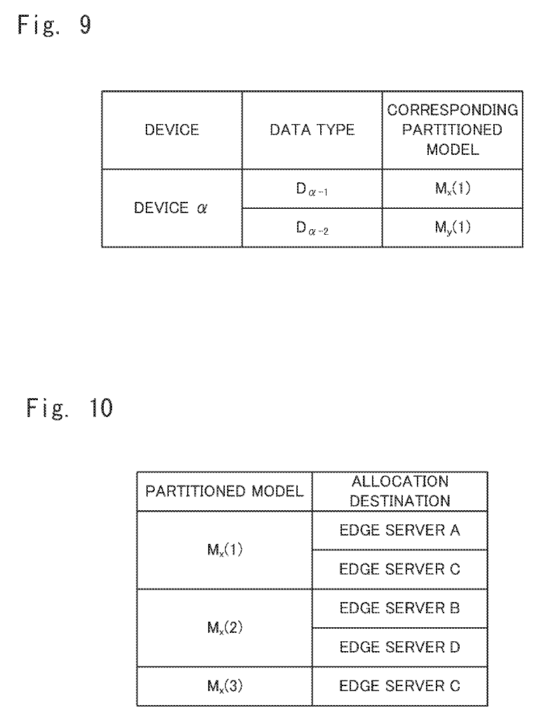

Note that the edge lists a list of all the edge servers 300 that constitute the edge computing system 100. Further, the edge server management information is information indicating the correspondence between the edge server 300 and the devices 400 connected to this edge server 300 (see FIG. 8). The partitioned model management information is information indicating, for each model, the order relation of the partitioned models and the correspondence between the partitioned model and the decryption key (see FIG. 7). The initial partitioned model information is information indicating the device 400 having transmitted data of a data type corresponding to the partitioned model (i.e., M(1)) to which original data (input data) is input (see FIG. 9). The allocation list is information indicating the allocation destination of each partitioned model (the identification information of the edge server 300 to which each partitioned model is allocated) (see FIG. 10).

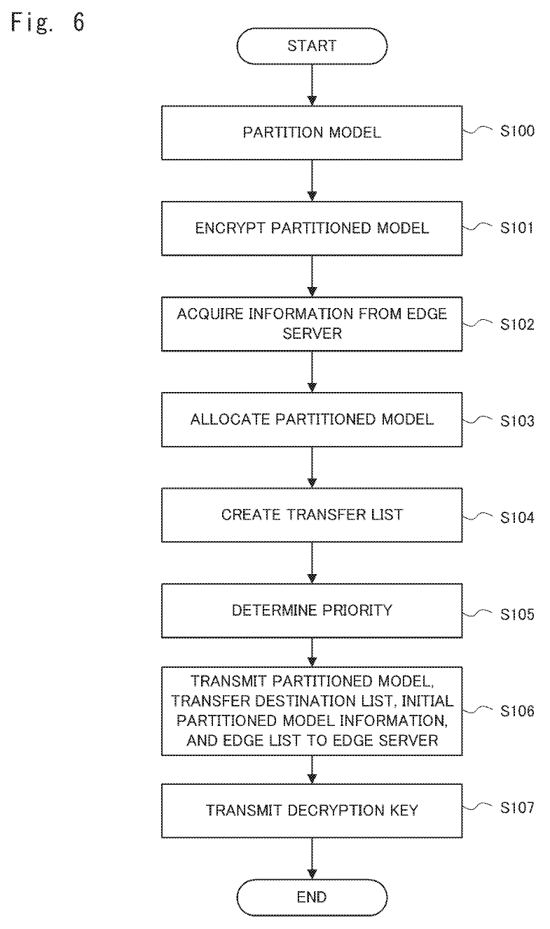

The operation of the backend server 200 is described next. FIG. 6 is a flowchart showing an example of an operation in the backend server 200. The operation of the backend server 200 is described hereinafter with reference to FIG. 6.

In Step 100 (S100), the model partitioning unit 201 partitions the model stored in the data storage unit 206. Specifically, the model partitioning unit 201 generates partitioned models M(1) to M(N). Further, the model partitioning unit 201 stores the order relation among the partitioned models as the partitioned model management information into the data storage unit 206 (see FIG. 7). Specifically, the model partitioning unit 201 stores the correspondence information between a partitioned model M(n) and a partitioned model to be executed subsequent to M(n) (i.e., partitioned model M(n+1)) as the partitioned model management information into the data storage unit 206. Note that n is an integer of 1 or more and less than N.

Next, in Step 101 (S101), the partitioned model encryption unit 202 performs encryption for each partitioned model and generates a decryption key. The partitioned model encryption unit 202 stores the encrypted partitioned model and the decryption key into the data storage unit 206. Further, the partitioned model encryption unit 202 adds the correspondence between the partitioned model and the decryption key to the partitioned model management information.

The partitioned model management information generated by the processing in Steps 100 and 101 is information in the format as shown in FIG. 7, for example. Although FIG. 7 shows the order relation of partitioned models and key information for the model X only, when there are a plurality of models, the partitioned model management information is created in the same manner for the models other than the model X.

Then, in Step 102 (S102), the edge communication unit 205 acquires, from each edge server 300, correspondence information between the edge server 300 and the devices 400 connected to this edge server 300 and information indicating a data type transmitted from each device 400. The edge communication unit 205 stores the correspondence information between the edge server 300 and the devices 400 as the edge server management information into the data storage unit 206. The edge server management information stored in the data storage unit 206 is information in the format as shown in FIG. 8, for example. Further, in Step 102, the edge communication unit 205 stores the identification information of all the edge servers 300 that have transmitted information to the backend server 200 as the edge list into the data storage unit 206. Furthermore, the edge communication unit 205 stores the initial partitioned model information created based on the information obtained in Step 102 and the partitioning result in Step 100 into the data storage unit 206. The initial partitioned model information stored in the data storage unit 206 is information in the format as shown in FIG. 9, for example.

After that, in Step 103 (S103), the partitioned model allocation unit 203 determines the allocation destination of each partitioned model based on the information stored in the data storage unit 206. The partitioned model allocation unit 203 follows the rules below, for example. Note that the partitioned model allocation unit 203 may carry out allocation according to some or all of the rules 1 to 3 described below.

<Rule 1> Allocate the partitioned model that extracts data to be analyzed from original data (i.e., M(1)) to all the edge servers 300 connected to the device 400 that transmits this original data

In this manner, the partitioned model allocation unit 203 allocates, to the edge server 300 connected and communicating with the device 400 that transmits original data, the partitioned model that requires an input of this original data.

It is thereby possible to avoid the communication load caused by transferring original data between the edge servers 300.

<Rule 2> Allocate a smaller number of partitioned models to the edge server 300 connected with a large number of devices 400

Specifically, the partitioned model allocation unit 203 allocates no more than a predetermined number of partitioned models to the edge server 300 where the number of connections exceeds a predetermined threshold, for example. In this manner, the partitioned model allocation unit 203 allocates, to the edge server 300, a certain number of partitioned models corresponding to the number of devices for each edge server 300.

It is thereby possible to prevent concentration of processing on the edge server 300 where the load of extraction processing of analysis target data from original data is heavy due to a large number of connected devices.

<Rule 3> Not allocate consecutive partitioned models M(n) and M(n+1) to the same edge server 300

The partitioned model allocation unit 203 allocates a first partitioned model and a second partitioned model to different edge servers 300. The second partitioned model is a partitioned model that includes a processing step subsequent to the first partitioned model.

It is thereby possible to, when information stored in the edge server 300 is improperly acquired, reduce damage due to leakage of information about the model compared with the case where consecutive partitioned models are stored in the same edge server 300.

As an example of allocation according to the rule 2 and the rule 3, a risk value when allocating consecutive partitioned models may be used. In an allocation method using a risk value, the more consecutive partitioned models are allocated to the same edge server 300, the higher the risk value set to this edge server 300 is. The partitioned model allocation unit 203 carries out allocation in consideration of the risk value and the number of connected devices and thereby makes distribution of the partitioned models.

For example, the partitioned model allocation unit 203 sets the risk value when allocating M(n+1) to the edge server 300 to which M(n) is allocated (which is referred to as the edge server A) to 1. Further, the partitioned model allocation unit 203 sets the risk value when allocating M(n+1) to the edge server 300 to which M(n−1) and M(n) are allocated (which is referred to as the edge server B) to 2. In this case, when a difference in the number of connected devices between the edge server A and the edge serve B is a predetermined threshold or less, the partitioned model allocation unit 203 allocates M(n+1) to the edge server A with a lower risk value. On the other hand, when the number of connected devices of the edge server A is larger than the number of connected devices of the edge server B by a predetermined value or more, it is expected that the load of extraction processing from original data in the edge server A is heavy. Therefore, the partitioned model allocation unit 203 allocates M(n+1) to the edge server B. Further, when the risk value of a certain edge server 300 is higher than a predetermined threshold, the partitioned model allocation unit 203 does not allocate consecutive partitioned models to this edge server 300 regardless of the number of connected devices of the edge server 300.

The partitioned model allocation unit 203 stores a correspondence table between the partitioned models and the edge servers 300 obtained by performing allocation according to the above-described rules as an allocation list into the data storage unit 206. The allocation list created in Step 103 is information in the format as shown in FIG. 10, for example.

In Step 104 (S104), the transfer destination list creation unit 204 creates a transfer destination list. Specifically, the transfer destination list is created as follows.

When the allocation destinations of partitioned models are determined according to the above-described rule 3, M(n) and M(n+1) are executed on the different edge servers 300. Therefore, it is necessary to transfer a computation result by M(n) to the edge server 300 having M(n+1). For this reason, the transfer destination list creation unit 204 adds information about the edge server 300 having the partitioned model M(n+1) including a processing step subsequent to the partitioned model M(n) as a transfer destination to the transfer destination list and stores the list into the data storage unit 206.

Further, the edge server 300 that receives data of a computation result by M(n) (i.e., the transfer destination edge server 300) needs to know by which partitioned model this data should be processed. For this reason, the transfer destination list creation unit 204 extracts information of the partitioned model to be executed subsequent to M(n) from the partitioned model management information stored in the data storage unit 206, adds this information to the transfer destination list and stores the list into the data storage unit 206.

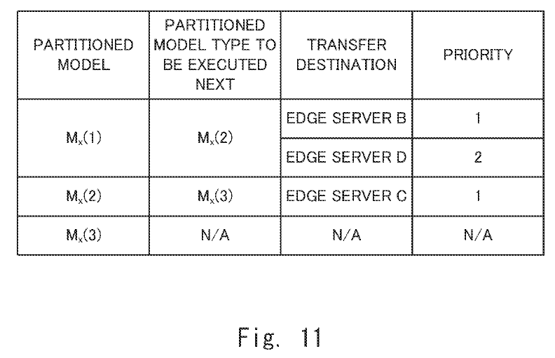

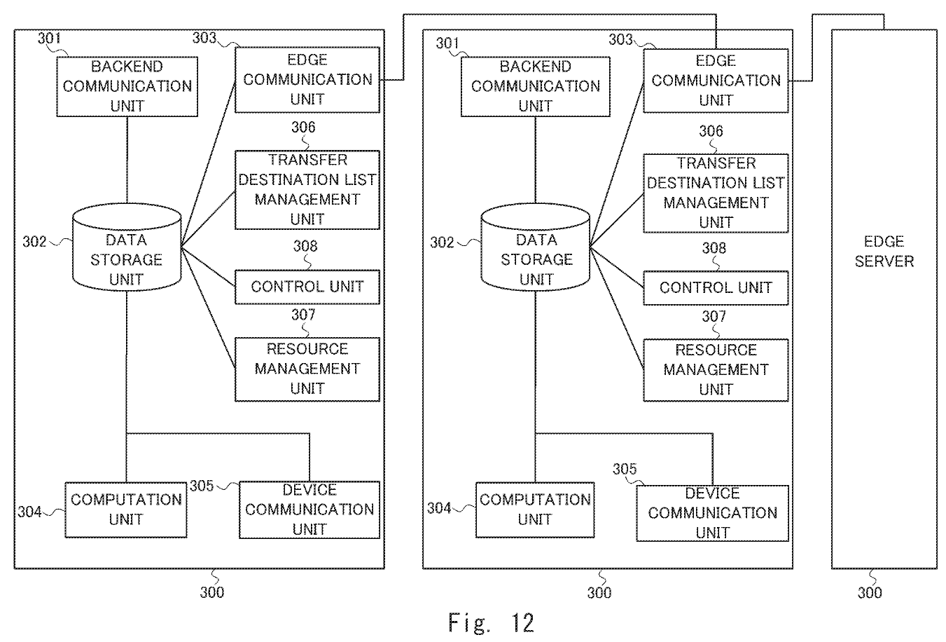

Then, in Step 105 (S105), the transfer destination list creation unit 204 updates the transfer destination list created in Step 104 by adding priority information. Specifically, in order to uniquely identify the transfer destination of data of a computation result by M(n), the transfer destination list creation unit 204 sets a transfer priority for each transfer destination of the partitioned model and updates the transfer destination list stored in the data storage unit 206. Note that, in consideration of the fact that the load on the edge server 300 is heavier as the number of connected devices is greater, the transfer destination list creation unit 204 sets a higher transfer priority to the edge server 300 with a smaller number of connected devices. In other words, the transfer destination list creation unit 204 determines the transfer priority according to the number of devices for each edge server 300. It is thereby possible to prevent concentration of processing on the edge server 300 on which heavy load is imposed. The transfer destination list created in Step 104 is information in the format as shown in FIG. 11, for example.

In Step 106 (S106), the edge communication unit 205 transmits the partitioned model, the transfer destination list, the initial partitioned model information and the edge list to the edge server 300. Note that the partitioned model transmitted in this step is encrypted as described earlier. Those information transmitted from the backend server 200 are received by a backend communication unit 301, which is described later, of the edge server 300.

After that, in Step 107 (S107), the edge communication unit 205 transmits, to the edge server 300, a decryption key for decrypting the partitioned model transmitted in Step 106. Note that, however, the edge servers 300 other than the edge server 300 with the highest priority of being a transfer destination does not necessarily perform computation using the partitioned model transmitted in Step 106. Therefore, the edge communication unit 205 transmits a decryption key for the partitioned model to the edge server 300 with the highest priority and does not transmit a decryption key to the edge servers 300 without the highest priority. Because a decryption key is not transmitted to the edge servers 300 with lower priority, the possibility of leakage of the decryption key is reduced. Note that the edge communication unit 205 transmits a decryption key also to the edge server 300 to which the partitioned model where original data is input (i.e., M(1)) is allocated.

The edge server 300 is described hereinafter.

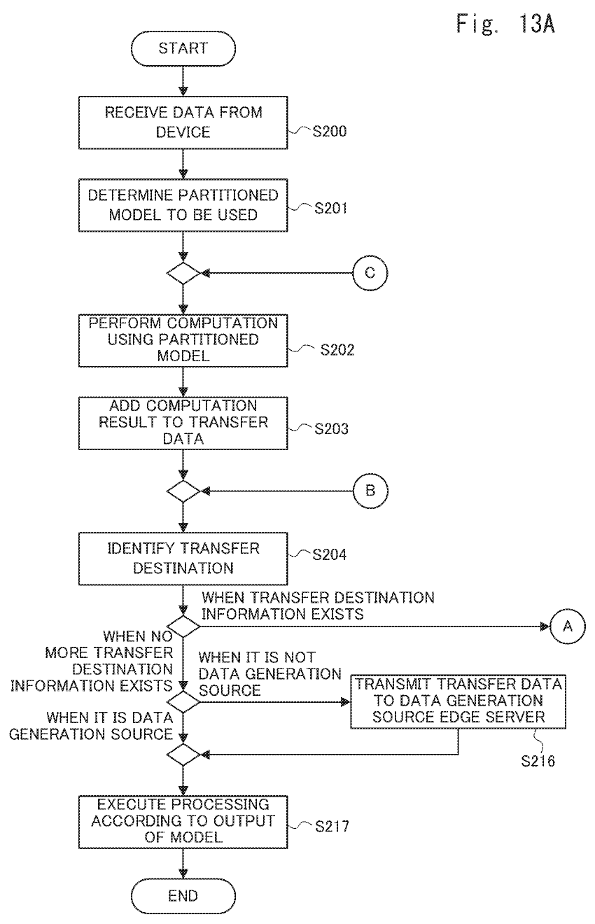

FIG. 12 is a block diagram showing an example of the functional configuration of the edge server 300. As shown in FIG. 12, each of the edge servers 300 includes a backend communication unit 301, a data storage unit 302, an edge communication unit 303, a computation unit 304, a device communication unit 305, a transfer destination list management unit 306, a resource management unit 307, and a control unit 308.

The backend communication unit 301 communicates with the backend server 200 through the network 500. The backend communication unit 301 receives a partitioned model, a decryption key for the partitioned model, the transfer destination list and the like, for example. Thus, the backend communication unit 301 is the equivalent of the partitioning information acquisition unit 31 in FIG. 1.

Further, the backend communication unit 301 transmits information about the device 400 connected to the edge server 300 (which is also referred to as device information), for example. Note that the device information contains the correspondence information between the edge server 300 and the devices 400 connected to this edge server 300, information indicating a data type transmitted from each of the devices 400 connected to this edge server 300 and the like.

The data storage unit 302 stores various data necessary for processing in the edge server 300. The data storage unit 302 stores device information, information received from the backend server 200 and the like, for example. Note that the computation unit 304, which is described later, performs processing by using the partitioned model and the decryption key stored in the data storage unit 302.

The edge communication unit 303 performs communication with another edge server 300. The edge communication unit 303 transmits and receives input/output data of a partitioned model, for example. The edge communication unit 303 is the equivalent of the computation result transfer unit 34 in FIG. 1.

The computation unit 304 is the equivalent of the computation unit 33 in FIG. 1, and it analyzes data received from the device 400 or another edge server 300 by using the partitioned model and the decryption key stored in the data storage unit 302.

The device communication unit 305 transmits and receives data to and from the device 400. For example, the device communication unit 305 receives data transmitted from the device 400, which is original data to be input to the partitioned model.

The transfer destination list management unit 306 manages the transfer destination list stored in the data storage unit 302. Further, the transfer destination list management unit 306 updates the transfer priority of each of the edge servers 300 in the transfer destination list.

The resource management unit 307 is the equivalent of the management unit 32 in FIG. 1, and it acquires the number of connected devices and the resource usage status (CPU utilization, memory utilization, disk capacity etc.) of the edge server 300, and determines whether to modify the transfer priority based on the number of connected devices and the resource usage status.

The control unit 308 performs various types of control related to processing of the elements described above in the edge server 300.

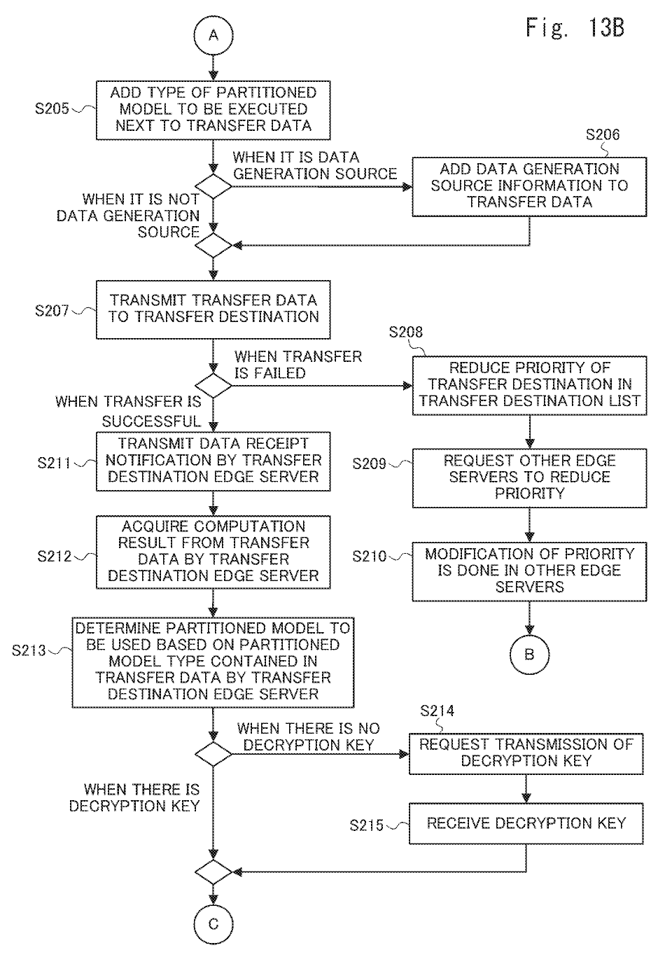

The operation of the edge server 300 is described hereinafter. FIGS. 13A and 13B are flowcharts showing an example of operations related to data analysis in the edge server 300. The operations related to data analysis in the edge server 300 are described hereinafter with reference to FIGS. 13A and 13B.

In Step 200 (S200), when data is transmitted from the device 400, the device communication unit 305 of the edge server 300 connected to this device 400 receives this data.

Next, in Step 201 (S201), the control unit 308 determines a partitioned model to be used by referring to the initial partitioned model information based on the data type of the data received in Step 200, and also passes the data to the computation unit 304.

Then, in Step 202 (S202), the computation unit 304 performs computation by using the partitioned model stored in the data storage unit 302. Note that, at this time, the computation unit 304 decrypts the partitioned model specified in Step 201 by using the decryption key, and performs computation by using the decrypted partitioned model.

Then, in Step 203 (S203), the computation unit 304 adds a computation result to transfer data, which is data to be passed to the edge server 300 that executes the subsequent processing step.

After that, in Step 204 (S204), the transfer destination list management unit 306 identifies the transfer destination of data of the computation result in Step 202 by referring to the transfer destination list stored in the data storage unit 302. When there is transfer destination information of the data, the process proceeds to Step 205, and when there is no transfer destination information of the data, the process proceeds to Step 216 or 217.

In Step 205 (S205), the control unit 308 adds, to the transfer data, the type of the partitioned model to be executed next by referring to the transfer destination list stored in the data storage unit 302. Further, the control unit 308 sets the edge server 300 with the highest priority of being a transfer destination as the transfer destination of the transfer data by referring to the transfer destination list.

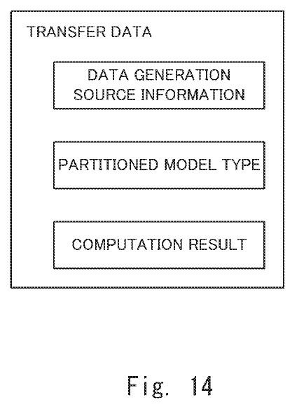

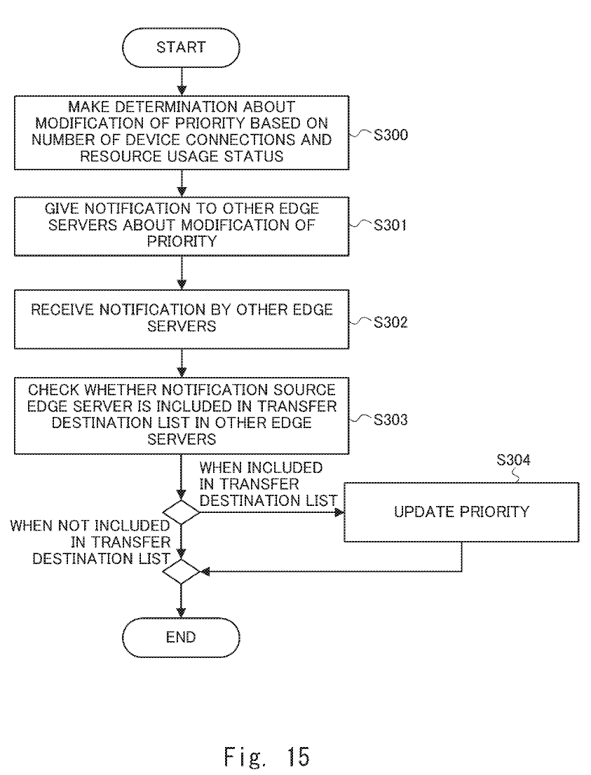

Further, when the server of its own is the server that has acquired the original data, i.e., when it is a generation source of data, the control unit 308 adds, to the transfer data, information about the server of its own as data generation source information (Step 206 (S206). Specifically, the data generation source information is information indicating in which of the edge servers 300 the original data used for processing whose result is to be transferred is acquired. Note that when the server that has acquired the original data is another edge server 300, Step 206 is not performed after Step 205, and the process proceeds to Step 207. The transfer data created in this manner is information in the format as shown in FIG. 14, for example.

In Step 207 (S207), the edge communication unit 303 transmits the transfer data to the edge server 300 with the highest priority of being a transfer destination.

The transfer destination edge server 300 (i.e., the edge server 300 at the receiving end) receives the transfer data and sends a data receipt notification to the transfer source edge server 300 (i.e., the edge server 300 at the transmitting end). When this data receipt notification is not sent from the transfer destination, there is a possibility that the transfer destination edge server 300 is in the state of being unable to communicate with another edge server 300 and fails to receive the transfer data due to reasons such as that it is disconnected from the network or powered off. The edge server 300 that does not send a data receipt notification in response to the transmission of the transfer data is referred to hereinafter as a communication-disabled edge server.

Thus, in Step 208 (S208), when the data receipt notification fails to be received, i.e., when there is no response from the transfer destination, the transfer destination list management unit 306 in the transfer source reduces the transfer priority of the communication-disabled edge server in the transfer destination list. Specifically, the transfer destination list management unit 306 updates the priority information in the transfer destination list. This inhibits transmission of the transfer data to the communication-disabled edge server.

Further, after Step 208, in Step 209 (S209), the edge communication unit 303 requests the other edge servers 300 not to transmit the transfer data to the communication-disabled edge server. To make this request, the edge communication unit 303 transmits a notification requesting a modification of the transfer priority of the communication-disabled server (to be specific, a modification of reducing the priority) to the edge servers 300 included in the edge list by using the edge list in the data storage unit 302. In this manner, when there is no response from the transfer destination, the edge communication unit 303 requests the other edge servers 300 to reduce the priority of this transfer destination edge server 300 in the transfer destination list (priority information). It is thereby possible to suppress similar failures in transfer by the other edge servers 300.

After Step 209, in Step 210 (S210), the edge server 300 that has received the notification requesting a modification of the transfer priority performs processing of modifying the transfer priority of the communication-disabled server. Note that, in this modification processing, the same processing as those in Steps 302 to 304 in FIG. 15, which are described later, is performed in the edge server 300 that has received the notification. After Step 209, the edge server 300 that has sent the notification performs the processing of Step 204 and the subsequent steps again. Specifically, transfer is attempted to the edge server 300 newly selected based on the updated transfer list.

On the other hand, when transfer is successful, processing for analysis is performed in the transfer destination edge server 300. The flow of a process in the transfer destination edge server 300 is described hereinbelow.

First, in Step 211 (S211), the edge communication unit 303 sends a data receipt notification to the transfer source.

Next, in Step 212 (S212), the control unit 308 acquires a computation result as input data from the received transfer data.

Then, in Step 213 (S213), the control unit 308 reads the partitioned model type contained in the received transfer data and determines the partitioned model to use.

A decryption key is required for execution of the partitioned model. However, at the time of model partitioning, the backend server 200 transmits the decryption key only to the edge server 300 with the highest transfer priority. Thus, there is a possibility that the edge server 300 that has newly becomes the transfer destination with the highest priority as a result of the processing in Steps 208 to 210 does not have the decryption key for the partitioned model. In this case, after the processing of Steps 214 and 215, which are described below, is performed, the processing of Step 202 and the subsequent steps is performed. On the other hand, when the edge server 300 has the decryption key for the partitioned model, the processing of Steps 214 and 215 is skipped, and the processing of Step 202 and the subsequent steps is performed.

When the decryption key for the partitioned model that is determined to be used in Step 213 is not stored in the data storage unit 302, the backend communication unit 301 requests the backend server 200 to transmit the decryption key corresponding to this partitioned model in Step 214 (S214). After that, in Step 215 (S215), the backend communication unit 301 receives the decryption key transmitted from the edge communication unit 205 of the backend server 200 that has received the request.

After that, the processing of Steps 202 to 215 is repeated until the processing of all of the sequence of partitioned models (i.e., M(1) to M(n)) is completed.

When the processing of the final partitioned model (i.e., M(n)) is completed, i.e., when there is no more transfer destination information of data, an output of analysis processing using the model is obtained. Therefore, processing corresponding to the output of the model is executed in Step 217 (S217). For example, based on the output of the model, an action such as feedback to the device 400 or the backend server 200 is carried out. Note that the processing in Step 217 is performed in the edge server 300 that is a source of the data input to this model, for example. Therefore, when the generation source of the data input to this model is not the server of its own, it is necessary to send the output back to the edge server 300 that is the generation source of the data. Thus, in Step 216 (S216) before Step 217 (S217), the edge communication unit 303 transfers the final computation result to the edge server 300 that is the generation source of the data by referring to the data generation source information contained in the transfer data.

A modification of the transfer priority according to the environment of the edge server 300 is described below. The connection status of the device 400 to the edge server 300 can vary from day to day. Therefore, the edge server 300 is not always in the state of being able to process the transferred data. In this embodiment, because the edge server 300 needs to execute the partitioned model (i.e., M(1)) that performs processing on the original data obtained from each device 400, the load becomes heavier as the number of connected devices increases. Further, for some data to be processed, a large amount of CPU or memory is used, or a data size to be stored on the disk is large. Therefore, in order to perform analysis processing appropriately, it is required to modify the transfer priority dynamically according to the environment of the edge server 300.

FIG. 15 is a flowchart showing an example of the modification operation of the transfer priority according to the environment of the edge server 300. The modification operation of the transfer priority in the edge server 300 is described hereinafter with reference to FIG. 15.

In Step 300 (S300), the resource management unit 307 recognizes the number of devices connected to the edge server 300 and the resource usage status (CPU utilization, memory utilization, disk utilization etc.). The resource management unit 307 then compares the number of devices with a first predetermined threshold and also compares the resource usage rate with a second predetermined threshold. When the number of devices or the resource usage rate exceeds the threshold, the resource management unit 307 determines to request reduction of the transfer priority of the server of its own.

Specifically, the resource management unit 307 compares the number of devices with a threshold, and requests the other edge servers 300 to update the priority information according to a comparison result. Further, the resource management unit 307 manages the resources of its own server, and requests the other edge servers 300 to update the priority information according to the usage status of the resources. It is thereby possible to control the occurrence of transfer to the server of its own according to the load condition of the server. Specifically, in the edge computing system 100, it is possible to appropriately allocate execution of analysis processing to the edge server 300.

When the number of devices or the resource usage rate that has exceeded a threshold falls below the threshold after requesting reduction of the transfer priority, the resource management unit 307 determines to make a request to set the transfer priority of its own server back to the original value. Specifically, the resource management unit 307 makes a request to increase the transfer priority of its own server.

In Step 301 (S301), given the determination of the resource management unit 307, the edge communication unit 303 sends a notification requesting a modification of the transfer priority to the edge servers 300 included in the edge list by using the edge list stored in the data storage unit 302.

In Step 302 (S302), the edge communication unit 303 of the other edge servers 300 receives this notification.

The partitioned model and the transfer destination list stored are different for each edge server 300. Therefore, it is necessary to check whether the edge server 300 that has sent the notification received in Step 302 is included in the transfer destination list. For this reason, in Step 303 (S303), the transfer destination list management unit 306 of the edge server 300 that has received the notification checks whether the edge server 300 that has sent the notification is included in the transfer destination list stored in the data storage unit 302.

When the edge server 300 that has sent the notification is included in the transfer destination list, the transfer destination list management unit 306 modifies the transfer priority in the transfer list according to the notification in Step 304 (S304). Specifically, the transfer destination list management unit 306 updates the priority information in the transfer destination list. On the other hand, when the edge server 300 that has sent the notification is not included in the transfer destination list, no action is carried out for the notification.

The edge computing system 100 according to this embodiment is described above. In the edge computing system 100, a modification of the priority is made dynamically according to the state of the edge server 300. It is thereby possible to appropriately execute processing in edge computing where the placement and configuration of devices are likely to vary. Further, in allocation of partitioned models and determination of a transfer priority performed in the backend server 200, the number of connected devices of each edge server 300 or the like is taken into consideration. This also enables appropriate distribution of program processing.

It should be noted that the present disclosure is not limited to the above-described embodiment and may be varied in many ways within the scope of the present disclosure. For example, in the above-described embodiment, allocation of partitioned models is determined based on the number of connected devices in the backend server 200. Besides, allocation of partitioned models may be determined according to the data type of original data acquired by the edge server 300, for example. For example, partitioned models other than the partitioned model (i.e., M(1)) that processes original data may be inhibited from being allocated to the edge server 300 that receives large-size data such as image data and audio data from the device 400. Then, a larger number of partitioned models may be allocated to the edge server 300 that receives light-weight data such as text data. In this manner, the partitioned model allocation unit 203 may adjust the number of partitioned models to be allocated to the edge server 300 according to the type of original data transmitted from the device 400 connected and communicating with the edge server 300. It is thereby possible to achieve allocation in consideration of the processing load caused by the data type. Note that the allocation according to the data type may be performed instead of the above-described rule 2 or performed in combination with the rule 2. Further, although a dynamic modification of the priority in the edge server 300 is made based on the number of devices or the resource usage rate in the above-described embodiment, a modification of the priority according to the data type may be made instead of or in combination with them.

The whole or part of the exemplary embodiments disclosed above can be described as, but not limited to, the following supplementary notes.

### Supplementary Note 1

An edge computing system comprising:
a backend server; and
a plurality of edge servers, wherein
the backend server comprises
   a model partitioning unit configured to partition a model into partitioned models, the model being a program that performs computation including a plurality of processing steps on input data;
   a partitioned model allocation unit configured to allocate each of the partitioned models to one or more of the edge servers;
   a priority creation unit configured to create priority information indicating which edge server among the plurality of edge servers to which the same partitioned model is allocated is to preferentially execute the partitioned model; and
   a partitioning information transmitting unit configured to transmit, to the edge server, the partitioned model, transfer destination information indicating an allocation destination of the partitioned model including a processing step subsequent to this partitioned model, and the priority information based on allocation by the partitioned model allocation unit,
each of the edge servers is connected and communicates with one or more devices that transmit the input data,
each of the edge servers comprises
   a partitioning information acquisition unit configured to acquire, from the backend server, the partitioned model, the transfer destination information and the priority information;
   a management unit configured to manage the number of connected and communicating devices;
   a computation unit configured to execute a computation using the partitioned model; and
   a computation result transfer unit configured to transfer a computation result of the computation unit to another one of the edge servers specified based on the transfer destination information and the priority information, and
the management unit compares the number of devices with a predetermined threshold, and requests the other edge servers to update the priority information according to a comparison result.

### Supplementary Note 2

The edge computing system according to Supplementary note 1, wherein the management unit further manages resources of its own server and requests the other edge servers to update the priority information according to a usage status of the resources.

### Supplementary Note 3

The edge computing system according to Supplementary note 1 or 2, wherein, when there is no response from a transfer destination, the computation result transfer unit requests the other edge servers to reduce priority of the edge server at the transfer destination in the priority information.

### Supplementary Note 4

The edge computing system according to any one of Supplementary notes 1 to 3, wherein the partitioned model allocation unit allocates, to the edge server, a certain number of the partitioned models corresponding to the number of devices for each of the edge servers.

### Supplementary Note 5

The edge computing system according to any one of Supplementary notes 1 to 4, wherein the partitioned model allocation unit allocates the partitioned model that requires an input of the input data to the edge server connected and communicating with a device that transmits the input data.

### Supplementary Note 6

The edge computing system according to any one of Supplementary notes 1 to 5, wherein
the partitioned model allocation unit allocates a first partitioned model and a second partitioned model to different ones of the edge servers, and
the second partitioned model is the partitioned model including a processing step subsequent to the first partitioned model.

### Supplementary Note 7

The edge computing system according to any one of Supplementary notes 1 to 6, wherein the partitioned model allocation unit adjusts the number of partitioned models to be allocated to the edge server according to a type of the input data transmitted from the device connected and communicating with the edge server.

### Supplementary Note 8

The edge computing system according to any one of Supplementary notes 1 to 7, wherein the priority creation unit determines priority according to the number of devices for each of the edge servers.

### Supplementary Note 9

An edge server connected and communicating with one or more devices that transmit input data to be input to a model being a program that performs computation including a plurality of processing steps, comprising:
a partitioning information acquisition unit configured to acquire, from a backend server, a partitioned model generated by partitioning the model, transfer destination information indicating another edge server that acquires the partitioned model including a processing step subsequent to this partitioned model, and priority information indicating which edge server among the plurality of edge servers that acquire the same partitioned model is to preferentially execute this partitioned model;
a management unit configured to manage the number of connected and communicating devices;
a computation unit configured to execute a computation using the partitioned model; and
a computation result transfer unit configured to transfer a computation result of the computation unit to another one of the edge servers specified based on the transfer destination information and the priority information, wherein
the management unit compares the number of devices with a predetermined threshold, and requests the other edge servers to update the priority information according to a comparison result.

### Supplementary Note 10

The edge server according to Supplementary note 9, wherein the management unit further manages resources of its own server and requests the other edge servers to update the priority information according to a usage status of the resources.

### Supplementary Note 11

A backend server comprising:
a model partitioning unit configured to partition a model into partitioned models, the model being a program that performs computation including a plurality of processing steps on input data;
a partitioned model allocation unit configured to allocate each of the partitioned models to one or more edge servers;
a priority creation unit configured to create priority information indicating which edge server among the plurality of edge servers to which the same partitioned model is allocated is to preferentially execute the partitioned model; and
a partitioning information transmitting unit configured to transmit, to the edge server, the partitioned model, transfer destination information indicating an allocation destination of the partitioned model including a processing step subsequent to this partitioned model, and the priority information based on allocation by the partitioned model allocation unit, wherein
the edge server is connected and communicates with one or more devices that transmit the input data, and
the partitioned model allocation unit allocates, to the edge server, a certain number of the partitioned models corresponding to the number of connected and communicating devices for each of the edge servers.

### Supplementary Note 12

The backend server according to Supplementary note 11, wherein the priority creation unit determines priority according to the number of devices for each of the edge servers.

### Supplementary Note 13

A system control method comprising:
managing the number of connections with a device that transmits input data to be input to a model being a program that performs computation including a plurality of processing steps;
acquiring, from a backend server, a partitioned model generated by partitioning the model, transfer destination information indicating another edge server that acquires the partitioned model including a processing step subsequent to this partitioned model, and priority information indicating which edge server among a plurality of edge servers that acquire the same partitioned model is to preferentially execute the partitioned model;
executing computation using the partitioned model;
transferring a computation result to another one of the edge servers specified based on the transfer destination information and the priority information; and
comparing the number of connections with a predetermined threshold, and requesting the other edge servers to update the priority information according to a comparison result.

### Supplementary Note 14

A non-transitory computer readable medium storing a program causing a computer to execute:
a management step of managing the number of connections with a device that transmits input data to be input to a model being a program that performs computation including a plurality of processing steps;
an acquisition step of acquiring, from a backend server, a partitioned model generated by partitioning the model, transfer destination information indicating another edge server that acquires the partitioned model including a processing step subsequent to this partitioned model, and priority information indicating which edge server among a plurality of edge servers that acquire the same partitioned model is to preferentially execute the partitioned model;
a computation step of executing computation using the partitioned model;
a transfer step of transferring a computation result to another one of the edge servers specified based on the transfer destination information and the priority information; and
a request step of comparing the number of connections with a predetermined threshold and requesting the other edge servers to update the priority information according to a comparison result.

According to the present disclosure it is possible to provide an edge computing system, an edge server, a system control method, and a program capable of appropriately allocating program processing to edge servers in an edge computing system.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An edge computing system comprising:
a backend server; and
a plurality of edge servers, wherein
the backend server comprises
a model partitioning unit configured to partition a model into partitioned models, the model being a program that performs computation including a plurality of processing steps on input data;
a partitioned model allocation unit configured to allocate each of the partitioned models to one or more of the edge servers;
a priority creation unit configured to create priority information indicating which edge server among the plurality of edge servers to which the same partitioned model is allocated is to preferentially execute the partitioned model; and
a partitioning information transmitting unit configured to transmit, to the edge server, the partitioned model, transfer destination information indicating an allocation destination of the partitioned model including a processing step subsequent to this partitioned model, and the priority information based on allocation by the partitioned model allocation unit,
each of the edge servers is connected and communicates with one or more devices that transmit the input data,
each of the edge servers comprises
a partitioning information acquisition unit configured to acquire, from the backend server, the partitioned model, the transfer destination information and the priority information;
a management unit configured to manage the number of connected and communicating devices;
a computation unit configured to execute a computation using the partitioned model; and
a computation result transfer unit configured to transfer a computation result of the computation unit to another one of the edge servers specified based on the transfer destination information and the priority information, and
the management unit compares the number of devices with a predetermined threshold, and requests the other edge servers to update the priority information according to a comparison result.

2. The edge computing system according to claim 1, wherein the management unit further manages resources of its own server and requests the other edge servers to update the priority information according to a usage status of the resources.

3. The edge computing system according to claim 1, wherein, when there is no response from a transfer destination, the computation result transfer unit requests the other edge servers to reduce priority of the edge server at the transfer destination in the priority information.

4. The edge computing system according to claim 1, wherein the partitioned model allocation unit allocates, to the edge server, a certain number of the partitioned models corresponding to the number of devices for each of the edge servers.

5. The edge computing system according to claim 1, wherein the partitioned model allocation unit allocates the partitioned model that requires an input of the input data to the edge server connected and communicating with a device that transmits the input data.

6. The edge computing system according to claim 1, wherein
the partitioned model allocation unit allocates a first partitioned model and a second partitioned model to different ones of the edge servers, and
the second partitioned model is the partitioned model including a processing step subsequent to the first partitioned model.

7. The edge computing system according to claim 1, wherein the partitioned model allocation unit adjusts the number of partitioned models to be allocated to the edge server according to a type of the input data transmitted from the device connected and communicating with the edge server.

8. The edge computing system according to claim 1, wherein the priority creation unit determines priority according to the number of devices for each of the edge servers.

9. An edge server connected and communicating with one or more devices that transmit input data to be input to a model being a program that performs computation including a plurality of processing steps, comprising:
a partitioning information acquisition unit configured to acquire, from a backend server, a partitioned model generated by partitioning the model, transfer destination information indicating another edge server that acquires the partitioned model including a processing step subsequent to this partitioned model, and priority information indicating which edge server among the plurality of edge servers that acquire the same partitioned model is to preferentially execute this partitioned model;
a management unit configured to manage the number of connected and communicating devices;
a computation unit configured to execute a computation using the partitioned model; and
a computation result transfer unit configured to transfer a computation result of the computation unit to another one of the edge servers specified based on the transfer destination information and the priority information, wherein
the management unit compares the number of devices with a predetermined threshold, and requests the other edge servers to update the priority information according to a comparison result.

10. The edge server according to claim 9, wherein the management unit further manages resources of its own server and requests the other edge servers to update the priority information according to a usage status of the resources.

11. A system control method comprising:
managing the number of connections with a device that transmits input data to be input to a model being a program that performs computation including a plurality of processing steps;
acquiring, from a backend server, a partitioned model generated by partitioning the model, transfer destination information indicating another edge server that acquires the partitioned model including a processing step subsequent to this partitioned model, and priority information indicating which edge server among a plurality of edge servers that acquire the same partitioned model is to preferentially execute the partitioned model;
executing computation using the partitioned model;
transferring a computation result to another one of the edge servers specified based on the transfer destination information and the priority information; and
comparing the number of connections with a predetermined threshold, and requesting the other edge servers to update the priority information according to a comparison result.
